(19) United States
(12) Patent Application Publication
(10) Pub. No.: US 2018/0076735 A1
(43) Pub. Date: Mar. 15, 2018

(54) Converter Arrangement and Method For Short-Circuit Protection Thereof

(71) Applicant: SIEMENS AKTIENGESELLSCHAFT, MUENCHEN (DE)

(72) Inventors: MARK-MATTHIAS BAKRAN, ERLANGEN (DE); JIANG XU, BAYREUTH (DE)

(21) Appl. No.: 15/563,681

(22) PCT Filed: Oct. 21, 2015
(86) PCT No.: PCT/EP2015/074388

§ 371 Date: Oct. 2, 2017

(30) Foreign Application Priority Data
Apr. 2, 2015 (EP) PCT/EP2015/057359

(51) Int. Cl. H02M 7/49; H02M 1/32

(52) U.S. Cl. CPC H02M 7/49; H02M 2007/4835; H02M 1/32

(57) ABSTRACT

A converter arrangement has a first phase module with a first phase module branch between a first AC voltage connection and a first DC voltage pole and a second phase module branch between the first AC voltage connection and a second DC voltage pole. A second phase module has third and fourth phase module branchs. The phase module branches have double-pole sub modules with a power semiconductor switch and an energy accumulator that can be bridged independently of the current direction by a bridging unit. A freewheeling path has a semiconductor element with a blocking direction and a pass direction. The converter arrangement is short-circuit protected when, in the event of a short-circuit on the DC voltage side, all sub modules are bridged independently of the current direction, and the DC voltage switch is switched off, to commutate a short-circuit current on the DC voltage side to the freewheeling path.

The invention relates to a converter arrangement having a first phase module extending between a first and a second DC voltage pole and having a first AC voltage connection, said first phase module comprising a first phase module branch extending between the first AC voltage connection and the first DC voltage pole and a second phase module branch extending between the first AC voltage connection and the second DC voltage pole, a second phase module extending between the first and the second DC voltage pole and having a second AC voltage connection, said second phase module comprising a third phase module branch extending between the second AC voltage connection and the first DC voltage pole and a fourth phase module branch extending between the second AC voltage connection and the second DC voltage pole, wherein each of the phase module branches comprises a series circuit containing two-pole submodules, wherein each submodule comprises at least one power semiconductor switch and an energy store and can be bypassed in a manner independent of current direction by means of a bypass unit arranged in parallel with the connection terminals of said sub module.

Bypassing in a manner independent of current direction is intended to exist here when the submodule is bypassed independently of the current direction.

A converter arrangement of the generic type is known from the article “Protection of Nonpermanent Faults on DC Overhead Lines in MMC-Based HVDC Systems” by Li et al, IEEE Trans. On Power Delivery, Vol. 28, NO. 1, January 2013.

Converter arrangements of this type are used, for example, in high-voltage DC (HVDC) transmission. In this case, electric power can be transmitted efficiently over long distances of hundreds and thousands of kilometers. The transmission usually takes place via DC voltage lines, which are realized in the form of underground or underwater cables or overhead lines. The DC voltage line usually comprises DC voltage links, which can be realized as overhead lines, underground lines or as ground conductors and which can be connected to the DC voltage poles of the converter arrangement. In the first case, in particular, environmental influences, such as lightning strikes and fallen trees, for example, can cause an often temporary short circuit in the DC voltage line. In the event of such DC-voltage-side faults, very high short-circuit currents potentially occur. The short-circuit currents can lead to damage in converter components as said short-circuit currents generally also flow through the phase module branches of the converter arrangement. This results in a need to disconnect the short-circuit currents for short-circuit protection of the converter arrangement. In the known converter arrangement, all of the power semiconductor switches in the submodules are closed as soon as a DC-voltage-side short circuit is detected by means of a suitable detector. At the same time, all the submodules are bypassed or their terminals are shorted by means of the associated bypass units, which, in the known converter arrangement, comprise antiparallel thyristors. To that end, a control unit provided for this purpose actuates the thyristors to change them to a conductive state. In this way, it is possible to cause, on the AC voltage side, a kind of symmetrical short circuit for ail the phases of an AC voltage grid that is connected to the converter arrangement. This achieves a situation in which no more power is fed into the DC voltage line connected on the DC voltage side to the converter arrangement. The short-circuit current in the DC voltage line is thus no longer maintained by power transmission. The short-circuit current still flowing on account of line inductances in the DC to voltage line then completely subsides.

Proceeding from the known converter arrangement, the object of the invention is that of further improving the short-circuit protection of the converter arrangement.

In a converter arrangement of the generic type, the object is achieved by a DC voltage switch in one of the two DC voltage poles and by a freewheeling path, which extends between a first DC voltage link that can be connected to the first DC voltage pole and a second DC voltage link that can be connected to the second DC voltage pole and comprises a semiconductor element having a reverse and a forward direction.

The invention comprises both two-phase and three-phase and also polyphase embodiments. In this case, in a three-phase embodiment, the converter arrangement has, for example, a fifth and a sixth phase branch, which are arranged in the manner of the known converter arrangement.

In accordance with the invention, it is of course possible to connect both the first DC voltage pole and the second DC voltage pole to the associated DC voltage links by means of at least one DC voltage switch in each case.

The first DC voltage pole can be realized, for example, as a positive bus bar and the second DC voltage pole can be realized, for example, as a neutral conductor. It is also conceivable for the first DC voltage pole to be realized as a neutral conductor and for the second DC voltage pole to be realized as a negative bus bar. Further variants are also accordingly possible, such as, for example, the first DC voltage pole being at a positive and the second DC voltage pole being at a negative high-voltage electrical potential. The converter arrangement according to the invention can furthermore be part of a bipolar high-voltage DC (HVDC) transmission installation.

The semiconductor element is expediently arranged in the freewheeling path in such a way that it blocks a flow of current via the freewheeling path in normal operation of the converter arrangement.

One advantage of the converter arrangement according to the invention is that the DC voltage switch can be used to commutate the short-circuit current flowing in the DC voltage line after the submodules have been bypassed onto the freewheeling path. In this way, advantageously, the DC-voltage-side short-circuit current does not then flow through the phase module branches of the converter arrangement, which improves the protection thereof as a result.

By combining the bypass units and the DC voltage switch, it is advantageously no longer necessary to configure the DC voltage switch or the reverse voltage thereof to switch at full DC-voltage-side voltage. Instead, it is sufficient for the DC voltage switch to be configured merely to commutate the short-circuit current onto the freewheeling path. For example, instead of a reverse voltage of 320 kV, a reverse voltage of 10 kV may now be sufficient. As a result, the power electronics circuit complexity for the DC voltage switch is advantageously reduced. In addition, the losses in normal operation of the converter arrangement are relatively low.

In accordance with a preferred embodiment of the invention, the freewheeling path comprises a parallel circuit, which is arranged in series with the semiconductor element and has an energy absorber element and an absorber switch arranged in parallel therewith. The energy absorber element, which can be a resistance element, for example, is con figured to divert the energy of the short-circuit current, for example by converting it to heat. A faster subsidence of the short-circuit current in the DC voltage line can be brought about in this way. The absorber switch, which is preferably a semiconductor switch, is arranged in a parallel circuit with the energy absorber element. Said absorber switch can be realized, for example, as a parallel circuit containing a power semiconductor, in particular an IGBT, and an antiparallel diode. A short-circuit current commutated onto the freewheeling path flows through the absorber switch when the absorber switch is in the forward position. If said absorber switch is turned off, the short-circuit current can be commutated onto the energy absorber element. The subsidence time of the short-circuit current, which is also referred to as the demagnetization time, is additionally able to be controlled in this way. The demagnetization time can be freely set, in particular, by the number of switching elements of the absorber switch and the corresponding absorber voltage of the energy absorber element. This in turn allows improved dimensioning, with respect to losses, of the other elements of the converter arrangement, such as the DC voltage switch, for example.

The absorber switch preferably comprises a series circuit containing absorber switching units, which each comprise a power semiconductor switch and a freewheeling diode arranged in antiparallel therewith. A modular design that is particularly cost-effective and reliable is realized in this way. The power semiconductor switches can be realized for example, by IGBT, IGCT or GTO switches.

The energy absorber element can also comprise a surge arrester or a series circuit containing surge arresters. An embodiment of this type has the advantage that additional protection of the converter arrangement is provided.

The bypass unit appropriately comprises a bypass branch, which is arranged in parallel with the two connections or poles of the submodules, with the result that a short circuit can be caused at the connections independently of the current direction. The bypass unit can be connected to a control device by means of which the bypass unit can be controlled and which can thus, in particular, initiate the bypassing of the submodules. The bypass unit preferably comprises antiparallel-connected thyristors. The thyristors are fired simultaneously in order to bypass submodules in a manner independent of current direction. A particularly advantageous and reliable bypass unit is provided in this way.

To detect a short circuit in the DC voltage line, it is possible to provide a detection device, for example a current measurement device, the output side of which is connected to the control device, for example.

In accordance with one advantageous embodiment of the invention, the semiconductor element in the freewheeling path comprises at least one diode and/or a thyristor. The diode and/or the thyristor prevent a short circuit between the two DC voltage poles of the DC voltage line in normal operation of the converter arrangement. The thyristor is appropriately fired in the event of a short circuit, in order to facilitate the short-circuit current via the freewheeling path. The freewheeling path appropriately has a polarity opposite to a rated potential. In this way, in accordance with the selected forward direction of the diode, essentially no current is carried by the freewheeling path in normal operation of the converter arrangement. The semiconductor element can also be formed by a series circuit containing a plurality of diodes and/or thyristors.

The sub modules of the converter arrangement can all be of the same type of design, but do not necessarily have to be.

The sub modules are preferably embodied as half-bridge circuits. Half-bridge circuits of this type are described, for example, in DE 101 03 031 B4. Submodules of this type are particularly cost-effective in operation on account of the relatively low losses. The power semiconductor switches of the submodules are power semiconductors that can be turned off in an appropriate manner, such as IGBTs, GTOs or the like, for example.

In accordance with one embodiment of the invention, the DC voltage switch comprises at least one power semiconductor switching module having a power semiconductor switch. The power semiconductor switch is, for example, what is known as a solid-state switch having an integrated-gate bipolar transistor (IGBT), with which a freewheeling diode is connected in antiparallel. The DC voltage switch can comprise a series circuit containing a plurality of power semiconductor switching modules of this kind. The number of power semiconductor switching modules in the series circuit is adapted appropriately to the respective application. In the event of a short circuit, the power semiconductor switching modules are switched off, for example by means of a control system configured for that purpose, with the result that the short-circuit current can commutate onto the freewheeling path.

The DC voltage switch preferably has a series circuit composed of the at least one power semiconductor switching module and at least one isolating switch. The isolating switch can be a mechanical switch. The DC voltage line can be interrupted by means of the isolating switch after the current in the isolating switch has subsided. After the isolating switch has been opened, the AC-voltage-side short-circuit current can also be interrupted in a simple manner, for example by closing the bypass units.

The DC voltage switch can further comprise at least one surge arrester. The at least one surge arrester can be arranged, for example, with the, which in parallel with the at least one power semiconductor switching module or the series circuit containing power semiconductor switching modules. The surge arrester restricts the voltage dropped across the power semiconductor switching modules and can furthermore be used as an energy-absorbing element.

As already explained above, the dielectric strength or blocking ability of the DC voltage switch of the converter arrangement according to the invention does not have to be configured for a DC-voltage-side rated voltage value, that is to say the voltage dropped between the two DC voltage connections during normal operation. The dielectric strength of the DC voltage switch is preferably less than 40%, preferably between 5% and 20%, of the rated voltage value. This reduces the electrical losses and hence the operating costs of the converter arrangement. In a specific case of a voltage of 300 kV to 400 kV, for example 320 kV, it is sufficient for the DC voltage switch to have a dielectric strength that is lower than 20 kV, preferably lower than 10 kV.

The invention further relates to a method for circuit protection of the converter arrangement according to the invention.

The object of the invention therefore consists in proposing such a method that is as simple and reliable as possible.

The invention achieves this object by way of a method in which, in the event of a DC-voltage-side short circuit, all submodules are bypassed in a manner independent of current direction, whereupon the DC voltage switch is turned off, with the result that a DC-voltage-side short-circuit current is commutated onto the freewheeling path.

In the method according to the invention, in the event of a DC-voltage-side short circuit, an AC-voltage-side short circuit is thus created in the converter arrangement by means of the bypass units, whereupon the short-circuit current from the phase module branches of the converter arrangement is actively commutated onto the freewheeling path by means of the DC voltage switch.

The advantages of the method according to the invention can be gathered from the previously described advantages of the converter arrangement according to the invention.

The absorber switch arranged in the freewheeling path is preferably turned off, with the result that a current in the freewheeling path is commutated onto the energy absorber element arranged in parallel with the absorber switch. Turning off is effected here as already described above after the short-circuit current has been commutated onto the freewheeling path and allows the demagnetization time in the freewheeling path to be set independently.

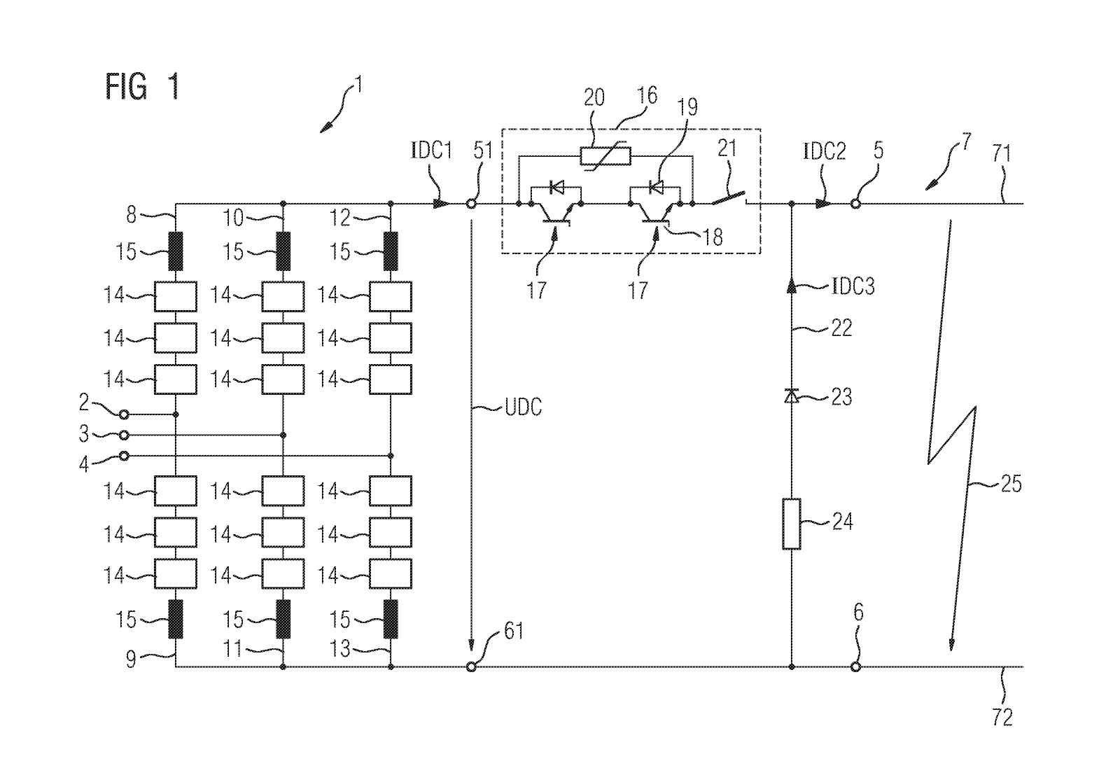

In the subsequent text, the invention will be explained in greater detail with reference to FIGS. 1 to 5.

FIG. 1 shows a schematic illustration of a first exemplary embodiment of a converter arrangement according to the invention;

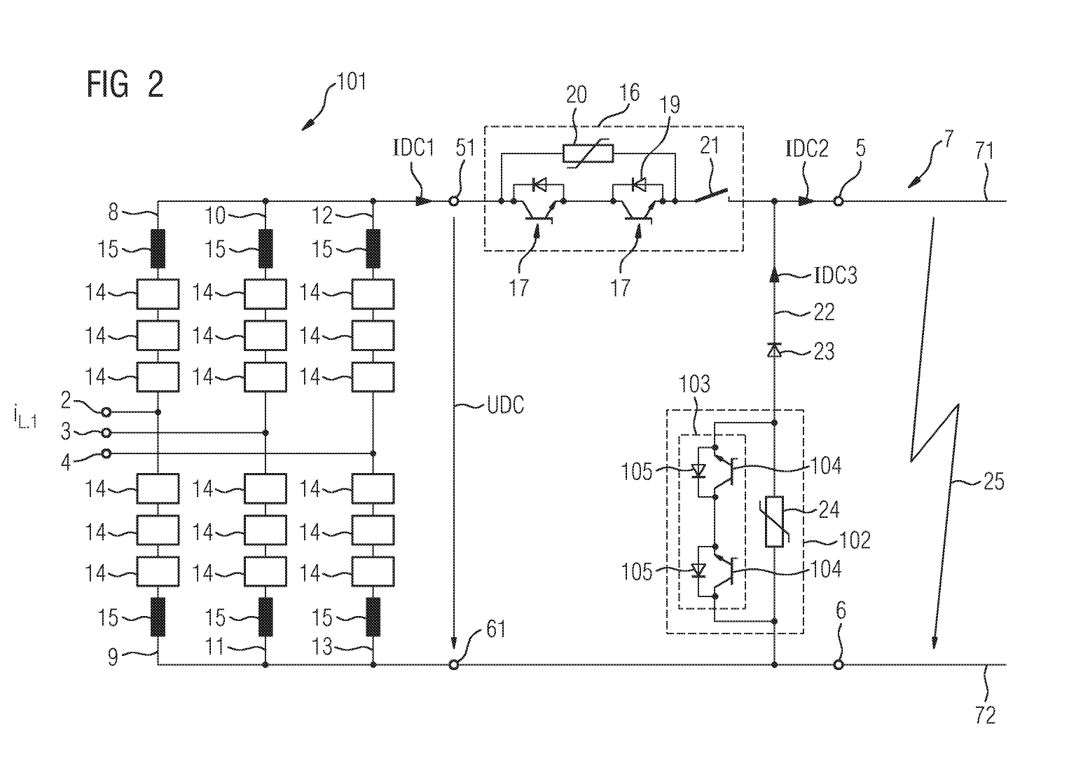

FIG. 2 shows a schematic illustration of a second exemplary embodiment of the converter arrangement according to the invention;

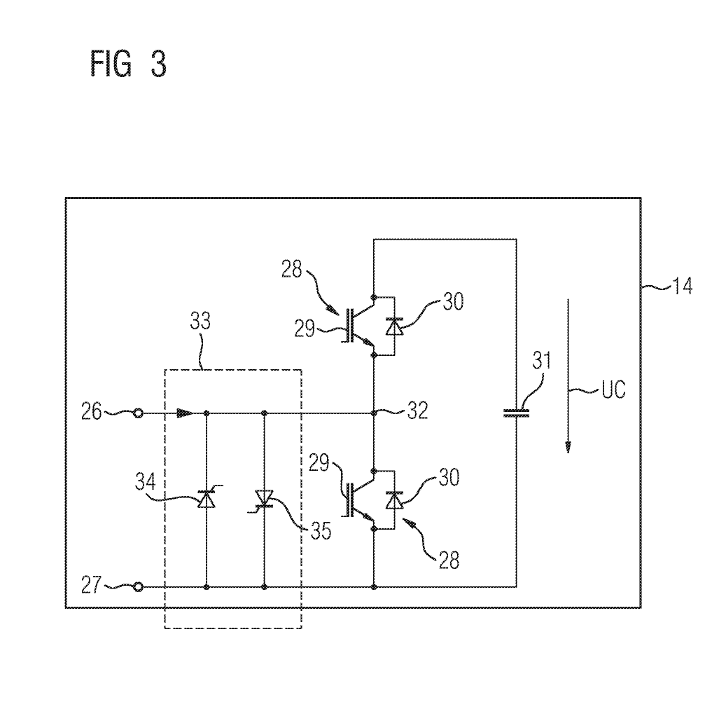

FIG. 3 shows a schematic illustration of a two-pole sub module of the converter arrangement of FIGS. 1 and 2;

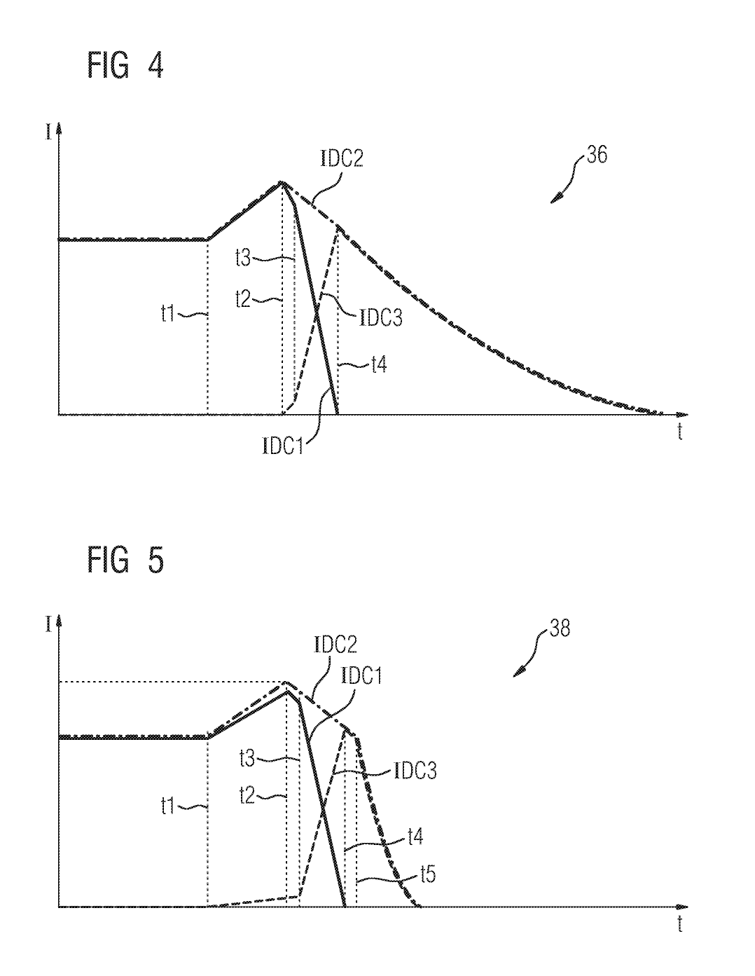

FIG. 4 shows the schematic profile of currents in the converter arrangement of FIG. 1;

FIG. 5 shows the schematic profile of currents in the converter arrangement of FIG. 2.

FIG. 1 illustrates an exemplary embodiment of a converter arrangement 1 according to the invention in detail. The converter arrangement 1 comprises three AC voltage connections 2, 3 and 4, which are configured to connect the converter arrangement 1 to a three-phase AC voltage grid. The converter arrangement 1 further comprises a first DC voltage connection 5 and a second DC voltage connection 6 for connection to a DC voltage line 7, namely to a first DC voltage link 71 and a second DC voltage link 72, respectively. In the present exemplary embodiment, the converter arrangement 1 is accordingly of three-phase design, wherein the invention is obviously not restricted to a three-phase embodiment. Said converter arrangement comprises a first phase branch 8, which extends between a first DC voltage pole 51 and the first AC voltage connection 2, a second phase module branch 9, which extends between the first AC voltage connection 2 and a second DC voltage pole 61, a third phase module branch 10, which extends between the first DC voltage pole 51 and a second AC voltage connection 3, a fourth phase module branch 11, which extends between the second AC voltage connection and the second AC voltage pole 61, a fifth phase module branch 12, which extends between the first DC voltage pole 51 and the third AC voltage connection 4, and a sixth phase module branch 13, which extends between the third AC voltage connection 4 and the second DC voltage pole 61. The first DC voltage pole 51 is connected to the first DC voltage connection 5. The second DC voltage pole 61 is connected to the second DC voltage connection 6.

The first phase module branch 8 comprises a first series circuit containing two-pole submodules 14 and a smoothing inductor 15 arranged in series with the series circuit containing the two-pole submodules 14. The phase module branches 9, 10, 11, 12, 13 each accordingly comprise a series circuit containing the submodules 14 and a smoothing inductor 15 connected in series therewith. In the exemplary embodiment of the converter arrangement 1 illustrated in FIG. 1, each of the phase module branches 8-13 has three submodules 14. However, the number of submodules 14 in each phase module branch is generally adapted to the respective application of the converter arrangement 1 and can be any desired number.

In the exemplary embodiment illustrated in FIG. 1, all the submodules 14 of the converter arrangement 1 are of the same type of design. The phase module branches 8-13 together with the AC voltage connections 2-4 and the DC voltage connections 5, 6 accordingly form what is known as a modular multilevel converter (MMC). A converter of this type is known, for example, from DE 10 103 031 E4. A predetermined voltage can be generated in the phase module branches 8-13 by means of a suitable control system (not illustrated in FIG. 1), with the result that a voltage UDC is dropped on the DC voltage side of the phase module branches 8-13.

The converter arrangement 1 further comprises a DC voltage switch 16, which is arranged between a potential point 51, between the first phase module branch 8 and the third phase module branch 10, and the first DC voltage connection 5. The DC voltage switch 16 has a series circuit containing power semiconductor switching modules 17, wherein each power semiconductor switching module 17 has an IGBT 18 and a freewheeling diode 19 connected in antiparallel therewith. A surge arrester 20 is arranged in parallel with the power semiconductor switching modules 17. An isolating switch 21 is further arranged in series with the power semiconductor switching modules 17, said isolating switch being a mechanical switch in the exemplary embodiment illustrated.

The converter arrangement 1 further comprises a freewheeling path 22. The freewheeling path 22 is arranged in parallel with the phase module branches 8-13 and extends between the two DC voltage links 71, 72. The freewheeling path 22 further has a semiconductor element 23, which is realized as a semiconductor diode. Furthermore, the freewheeling path 22 has an energy absorber element 24, which is arranged in series with the semiconductor element 23.

A converter arrangement 1 of this type can be protected against damage, in particular, in the event of a DC-voltage-side short circuit. The short circuit is indicated in FIG. 1 by the jagged arrow 25.

The subsequent FIG. 4 will deal with the mode of operation of the converter arrangement 1 and the protection function thereof in more detail, wherein the current through the DC voltage switch 16 is denoted IDC1, the current in the DC voltage line 7 is denoted IDC2 and the current in the freewheeling path 22 is denoted ICD3.

The sub modules 14 of the converter arrangement 1 of FIG. 1 are realized as half-bridge circuits.

FIG. 2 illustrates a second exemplary embodiment of a converter arrangement 101 according to the invention.

Identical and similar elements of the converter arrangements 1 and 101 are provided with identical reference numerals for reasons of clarity.

In contrast to the converter arrangement 1, the freewheeling path 22 of the converter arrangement 101 has a parallel circuit 102, which is arranged in series with the semiconductor element 23 and has an energy absorber element 24 and an absorber switch 103 arranged in parallel therewith. The energy absorber element 24 is a surge arrester. The absorber switch 102 comprises a series circuit containing power semiconductor switches 104, IGBTs in the exemplary embodiment, with each of which a freewheeling diode 105 is connected in antiparallel. In FIG. 2, the series circuit has two power semiconductor switches 104, the number of which can, however, vary with the respective application and is basically arbitrary.

The mode of operation of the converter arrangement 101 and the protection function thereof is similar to that of the converter arrangement 1. The subsequent FIG. 5 will deal with the mode of operation of the converter arrangement 101 and the protection function thereof in more detail. Here, as previously, the current through the DC voltage switch 16 is denoted IDC1, the current in the DC voltage line 7 is denoted IDC2 and the current in the freewheeling path 22 is denoted IDC3.

FIG. 3 shows the basic design of one of the submodules 14 of the converter arrangement 1 or 101 of FIG. 1 or 2. The submodule 14 comprises a first connection terminal 26 and a second connection terminal 27. The submodule 14 further comprises two power semiconductor switching units 28 connected in series. Each of the two power semiconductor switching units 28 comprises a power semiconductor switch 29, which, in the exemplary embodiment illustrated in FIG. 2, is an IGBT, and a freewheeling diode 30 connected in antiparallel therewith. An energy store 31 is arranged in parallel with the series circuit containing the power semiconductor switching units 28, said energy store being a power capacitor in the present exemplary embodiment of the submodule 14. A voltage that is denoted UC in FIG. 2 is dropped across the power capacitor 31.

The second connection terminal 27 of the submodule 14 is connected to a pole of the power capacitor 31, the first connection terminal 26 of the submodule 14 is connected to a potential point 32 between the two power semiconductor switching units 28.

The sub module 14 further comprises a bypass unit 33, which is connected to the connections 26, 27 in such a way that it can bypass the submodule 14 or can short the two connection terminals 26, 27. The bypass unit 33 has two antiparallel-connected thyristors 34 and 35, which can provide bypassing of the submodule 40 in a manner independent of current direction. In order to bypass the submodule 14, the two thyristors are actuated to fire at the same time by means of a control unit (not illustrated).

FIG. 4 shows a sketch of the time profiles of the three currents IDC1, IDC2 and IDC3 of the exemplary embodiment of the converter arrangement 1 of FIG. 1 in a graph 36. The elapsed time is plotted on the abscissa t of the graph 36 and the current values at given times are plotted on the ordinate I. The current direction of the three currents IDC1, IDC2, IDC3 in normal operation is indicated in FIG. 1 by corresponding arrows.

A fault, for example a short circuit in the DC voltage line 7, occurs at an instant that is distinguished in the graph 36 as a broken line t1. From this instant, the currents IDC1 and IDC2 increase. The values of the currents IDC1 and IDC2 are the same up to an instant distinguished by a broken line t2. It can be seen that the freewheeling path essentially has no current in normal operation on account of the polarity of the diode 23 counter to the rated potential present in normal operation.

At the instant denoted t2, the fault is detected by means of a suitable fault recognition device. Consequently, all bypass units 33 in the phase module branches 8 to 13 are actuated to bypass the submodules 14 associated with them, that is to say the thyristors 34 and 35 are fired in each submodule 14. In this way, the phases of the AC voltage grid connected on the AC voltage side to the AC voltage connections 2, 3, 4 are shorted. In other words, the AC voltage grid is isolated from the DC voltage side with the result that the short-circuit current can no longer be fed from the AC voltage grid, that is to say can no longer be supplied with power. The values of the currents IDC1 and IDC2 decrease from this instant.

At an instant distinguished by the broken line t3, the power semiconductor switches 18 of the power semiconductor switching modules 17 are actuated to turn off. The current is commutated onto the freewheeling path 22 on account of the reverse voltage of the power semiconductor switches 17 with the aid of the surge arrester 20, which can also be realized as a series circuit containing surge arresters. The value of the current IDC1 decreases very quickly to zero from this instant.

As soon as IDC1 has decreased to zero or almost to zero, which in FIG. 3 occurs at an instant indicated by a broken line denoted t4, the mechanical isolating switch 21 can be opened. The remaining short-circuit current IDC3 in the DC voltage line 7, whose value then corresponds to the value of the current IDC2, flows entirely via the freewheeling path 22 from this instant. IDC3 subsides in accordance with an RL constant of the DC voltage line 7. The subsidence of the current IDC3 is additionally to accelerated by the energy absorber element 24.

FIG. 5 shows a sketch of the time profiles of the three currents IDC1, IDC2 and IDC3 of the exemplary embodiment of the converter arrangement 101 of FIG. 2 in a graph 37. The elapsed time is plotted on the abscissa t of the graph 37 and the current values at given times are plotted on the ordinate 1. The current direction of the three currents IDC1, IDC2, IDC3 in normal operation is indicated in FIG. 2 by corresponding arrows.

A fault, for example a short circuit in the DC voltage line 7, occurs at an instant that is distinguished in the graph 37 as a broken line t1. From this instant, the currents IDC1 and IDC2 increase. The values of the currents IDC1 and IDC2 are substantially the same up to an instant distinguished by a broken line t2. It can be seen that the freewheeling path essentially has no current in normal operation and the current IDC3 has a relatively small magnitude between the instants t1 and t2 on account of the polarity of the diode 23 counter to the rated potential present in normal operation.

At the instant denoted t2, the fault is detected by means of a suitable fault recognition device. Consequently, all bypass units 33 in the phase module branches 8 to 13 of the converter arrangement 101 are actuated to bypass the submodules 14 associated with them, that is to say the thyristors 34 and 35 are fired in each submodule 14. In this way, the phases of the AC voltage grid connected on the AC voltage side to the AC voltage connections 2, 3, 4 are shorted. In other words, the AC voltage grid is isolated from the DC voltage side with the result that the short-circuit current can no longer be fed from the AC voltage grid, that is to say can no longer be supplied with power. The values of the currents IDC1 and IDC2 decrease from this instant.

At an instant distinguished by the broken line t3, the power semiconductor switches 18 of the power semiconductor switching modules 17 are actuated to turn off. The current is commutated onto the freewheeling path 22 on account of the reverse voltage of the power semiconductor switches 17 with the aid of the surge arrester 20, which can also be realized as a series circuit containing surge arresters. The value of the current IDC1 decreases very quickly to zero from this instant.

As soon as IDC1 has decreased to zero or almost to zero, which in FIG. 3 occurs at an instant indicated by a broken line denoted t4, the mechanical isolating switch 21 can be opened. The remaining short-circuit current IDC3 in the DC voltage line 7, whose value then corresponds to the value of the current IDC2, flows entirely via the freewheeling path 22 from this instant. IDC3 subsides in accordance with an RL constant of the DC voltage line 7.

At an instant distinguished in FIG. 5 by a broken line t5, the power semiconductor switches 104 of the absorber switch 103 are actuated to turn off. At this instant, the AC side is completely isolated from the DC side. By turning off the absorber switch 103, the current IDC3 is commutated onto the energy absorber element 24. The short-circuit current decreases rapidly. The demagnetization time can be set freely here by the number of power semiconductor switches 104 and the voltage characteristic curve of the energy absorber element 24, the surge arrester in the example of FIG. 2.

1-12. (canceled).

13. A converter arrangement, comprising:
a first phase module extending between a first DC voltage pole and a second DC voltage pole and having a first AC voltage connection, said first phase module including a first phase module branch extending between the first AC voltage connection and the first DC voltage pole and a second phase module branch extending between the first AC voltage connection and the second DC voltage pole;
a second phase module extending between the first DC voltage pole and the second DC voltage pole and having a second AC voltage connection, said second phase module including a third phase module branch extending between the second AC voltage connection and the first DC voltage pole and a fourth phase module branch extending between the second AC voltage connection and the second DC voltage pole;
each of said first and second phase module branches including a series circuit containing a plurality of two-pole sub modules each containing at least one power semiconductor switch and an energy storage device and a bypass unit connected in parallel with the connection terminals of said sub modules and configured to enable a bypass of said sub modules independently of a current flow direction;
a DC voltage switch disposed in one of the two said DC voltage poles; and
a freewheeling path extending between a first DC voltage link that can be connected to the first DC voltage pole and a second DC voltage link that can be connected to the second DC voltage pole and including a semiconductor element having a reverse direction and a forward direction.

14. The converter arrangement according to claim 13, wherein said freewheeling path comprises a parallel circuit, which is connected in series with said semiconductor element and has an energy absorber element and an absorber switch connected in parallel with said energy absorber.

15. The converter arrangement according to claim 14, wherein said absorber switch comprises a series circuit containing absorber switching units, which each comprise a power semiconductor switch and a freewheeling diode connected in antiparallel therewith.

16. The converter arrangement according to claim 13, wherein said bypass unit comprises antiparallel-connected thyristors.

17. The converter arrangement according to claim 13, wherein said semiconductor element in said freewheeling path comprises at least one diode and/or a thyristor.

18. The converter arrangement according to claim 13, wherein said sub modules are half-bridge circuits.

19. The converter arrangement according to claim 13, wherein said DC voltage switch comprises at least one power semiconductor switching module having a power semiconductor switch.

20. The converter arrangement according to claim 19, wherein said DC voltage switch has a series circuit composed of said at least one power semiconductor switching module and at least one isolating switch.

21. The converter arrangement according to claim 19, wherein said DC voltage switch comprises a surge arrester connected in parallel with said at least one power semiconductor switching module.

22. The converter arrangement according to claim 13, wherein said DC voltage switch has a dielectric strength less than 20 kV.

23. A method for a short-circuit protection of a converter arrangement, the method comprising:
providing a converter arrangement according to claim 13 and, on occasion of a DC-voltage-side short circuit:
bypassing all sub modules of the converter arrangement independent of a current direction; and
subsequently turning off the DC voltage switch to cause a DC-voltage-side short-circuit current to be commutated onto the freewheeling path.

24. The method according to claim 23, which comprises turning off an absorber switch arranged in the freewheeling path, to thereby commutate a current in the freewheeling path onto an energy absorber element arranged in parallel with the absorber switch.
